(19) United States
(12) Patent Application Publication
(10) Pub. No.: US 2020/0122289 A1
(43) Pub. Date: Apr. 23, 2020

(54) THIN SHEETS MADE OF ALUMINIUM-COPPER-LITHIUM ALLOY FOR AIRCRAFT FUSELAGE MANUFACTURE

(71) Applicant: CONSTELLIUM ISSOIRE, Issoire (FR)

(72) Inventors: Maria Belen DAVO GUTIERREZ, Coublevie (FR); Lionel PEGUET, Quaix en Chartreuse (FR); Jean-Sylvestre SAFRANY, Voiron (FR); Frank EBERL, Issoire (FR); Thibaud BRET, Issoire (FR)

(73) Assignee: CONSTELLIUM ISSOIRE, Issoire (FR)

(21) Appl. No.: 16/619,195

(22) PCT Filed: Jun. 14, 2018
(86) PCT No.: PCT/FR2018/051421

§ 371 Date: Dec. 4, 2019

(30) Foreign Application Priority Data
Jun. 19, 2017 (FR) 17/55582

(51) Int. Cl. B24B 29/00; B24B 39/00; B24B 39/06; C22C 21/12; C22F 1/057; B64C 1/00

(52) U.S. Cl. CPC B24B 29/005; B24B 39/006; B24B 39/06; B64C 2001/0081; C22F 1/057; B64C 1/00; C22C 21/12

(57) ABSTRACT

A method for manufacturing a brushed rolled product made from Al—Cu—Li alloy with a thickness of less than 12 mm, including the steps of producing a rolled product, solution heat treatment and quenching, stress relieving, optionally tempering, and brushing, wherein the brushing tool applies a force to the rolled product generating residual compressive stresses at the surface of the brushed product; eliminates a thickness of at least 9 μm from the surface of the non-brushed rolled product; wherein the brushing step comprises at least one circular brushing motion. The rolled product obtained by the method according to the invention is advantageous. The use of such a product in an aircraft fuselage panel is advantageous.

### FIELD OF THE INVENTION

The present invention relates in general to brushed rolled products made of 2XXX alloy containing aluminum comprising lithium, more particularly, such products useful in the aeronautics and space industry appropriate for a use in fuselage uses. The invention also relates to the methods for manufacturing such products.

### PRIOR ART

Rolled products made of aluminum alloy are developed in order to produce fuselage elements intended namely for the aeronautics industry and for the space industry. Al—Cu—Li alloys are of particular interest for manufacturing this type of product since they offer property compromises generally higher than the conventional alloys, namely in terms of compromise between fatigue, damage tolerance and mechanical strength.

The patent application WO2013/054013 describes the method for manufacturing a rolled product, in particular for the aeronautics industry, containing an aluminum alloy having a composition of 2.1 to 3.9% Cu by weight, 0.7 to 2.0% Li by weight, 0.1 to 1.0% Mg by weight , 0 to 0.6% Ag by weight, 0 to 1% Zn by weight, at most 0.20% Fe+Si by weight, at least one element chosen from Zr, Mn, Cr, Se, Hf and Ti, the quantity of said element , if selected, of 0.5 to 0.18% by weight for Zr, of 0.1 to 0.6% by weight for Mn, of 0.05 to 0.3% by weight for Cr, of 0.02 to 0.2% by weight for Se, of 0.05 to 0.5% by weight for Hf and of 0.01 to 0.15% by weight % for Ti, the other elements representing at most 0.05% by weight each and 0.15% by weight total, the rest being aluminum, said method comprising a levelling and/or a stretching with a total deformation of at least 0.5% and less than 3%, and short heat treatment in which the sheet metal reaches a temperature of between 130 and 170° C. for 0.1 to 13 hours. The advantageous compromise of the properties of the wrought products made of Al—Cu—Li alloy allow in particular to reduce the thickness of these products, thus maximizing even more the reduction in weight that they provide. The routine stresses are, however, thereby increased, thus leading to greater risks of initiation of fatigue cracks. It is therefore of interest to improve the fatigue resistance of the products made of Al—Cu—Li alloy, namely those of the anodized products such as fuselage sheets.

The article by Nazida Sidhom et al entitled “Effects of Brushing and Shot-Peening Residual Stresses on the Fatigue Resistance of Machined Metal Surfaces: Experimental and predicting Approaches”, Materials Science Forum vol. 681, pp 290-295 (2011) describes the linear mechanical brushing of sheet metal made of AA5083H11 alloy and its effect on the compression stresses, the roughness and the fatigue performance.

The patent application US2009/029631 describes a method and apparatus for conditioning a metal surface typically having irregular surface contours, by rubbing the metal surface with a surface-conditioning device comprising a plurality of hairs that are in contact with the metal surface during the rubbing and reduce the tensile stress or the degraded layer of the metal surface.

The patent application DE102010043285 describes the treatment of a component in which at least a portion of the surface of the component is bombarded with an agent for generating residual compression stresses, the projection medium comprising a liquid and particles designed in such a way that, when the surface of the component is irradiated, substantially the state of residual stress of the component is modified.

The U.S. Pat. No. 5,791,009 describes a manufacturing method in which residual stresses are intentionally imposed on the lower working surface and / or on the upper mounting surface of a trowel blade. Stresses can be imposed, for example, by the shot blasting of glass beads, shot blasting, rolling and / or the brushing of the metal trowel blade.

On the other hand, during the manufacturing of such products, it is important to take into account the stresses to which the semi-finished products are subjected to in transit from the manufacturer to the airframe manufacturer. During such transit, the semi-finished products are generally non-anodized and sometimes subjected to extreme temperature and humidity conditions. Moreover, they can be stored for very long periods. Despite these conditions, it is important for the manufacturer to be able to guarantee the retention of the properties of the semi-finished products, namely a satisfactory surface appearance, in particular in terms of surface corrosion. The semi-finished products made of Al—Cu—Li alloys, even more the Al—Cu—Li—Mg alloys, have a more particular tendency to react when they are stored over very long periods in extreme temperature and humidity conditions.

There is a need for products made of aluminum-copper-lithium alloy having improved properties with respect to those of the known products, in particular in terms of fatigue resistance, properties of static mechanical strength and corrosion resistance, while having a low density. Moreover there is a need for a simple and economical method for obtaining these sheets.

### OBJECT OF THE INVENTION

The object of the invention is a method for manufacturing a brushed rolled product made of Al—Cu—Li alloy having a thickness of less than 12 mm comprising a step of brushing such that the brushing tool:
generates residual compression stresses at the surface of the brushed product;
eliminates a thickness at least equal to 9pm of the surface of the non-brushed rolled product,
wherein the brushing step comprises at least one brushing of the circular type.

The object of the invention is also a brushed rolled product made of Al—Cu—Li alloy having a thickness of less than 12 mm obtained by the method of the invention.

Finally, the object of the invention is the use of a brushed rolled product obtained according to the method according to the invention in a fuselage panel for an aircraft.

### DESCRIPTION OF THE DRAWINGS

FIG. 1 is the diagram of the test pieces used for the smooth fatigue tests. The dimensions are given in mm.

FIG. 2 schematically shows various types of brushing: FIG. 2a linear brushing, FIG. 2b circular and linear brushing, FIG. 2c circular and orbital brushing.

### DESCRIPTION OF THE INVENTION

Unless otherwise mentioned, all the indications relating to the chemical composition of the alloys are expressed as a percentage by weight based on the total weight of the alloy. The expression 1.4 Cu means that the concentration of copper expressed as a % by weight is multiplied by 1.4. The designation of the alloys is carried out in accordance with the regulations of The Aluminum Association, known to a person skilled in the art. When the concentration is expressed in ppm (parts per million), this indication also refers to a mass concentration.

Unless otherwise mentioned, the definitions of the metallurgical states indicated in the European standard EN 515 (1993) apply.

Unless otherwise mentioned, the definitions of the standard EN 12258 apply.

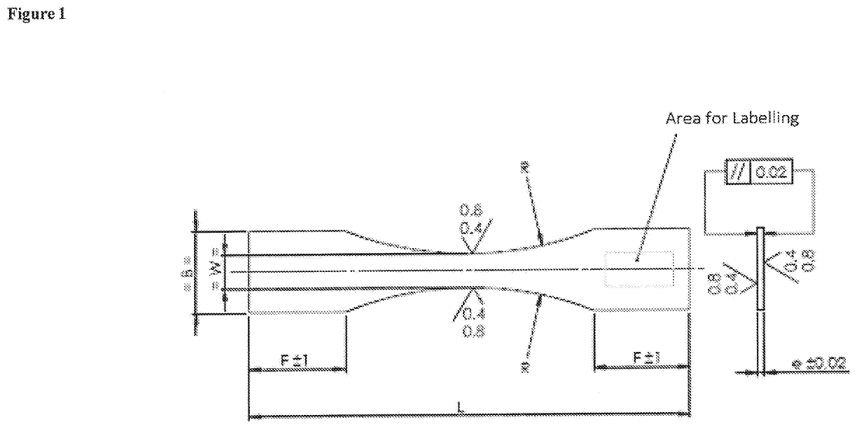

The fatigue properties on smooth test pieces are measured in ambient air for variable stress levels, at a frequency of 40 Hz, a stress ratio R=0.1, on test pieces as shown in FIG. 1, Kₜ=1, sampled over the full thickness in the sheet metal in the direction T-L.

The fatigue properties are evaluated by determination of the average breaking stress value σ_{A} at 100,000 cycles.

To do this, a stress value σₘₐₓ is determined for each sheet metal tested by carrying out a staircase-method fatigue test with an increasing stress (+20 MPa for each non-breaking plateau at 100,000 cycles). Thus, a first fatigue test is carried out with a stress σₓ, if the test piece does not break after 100,000 cycles, the test continues with a stress σₓ+20 MPa. The stress σₘₐₓ corresponds to the stress σₓ+(n*20), in MPa, at which the rupture takes place.

For each sheet metal, three fatigue tests are thus carried out at the stress value σₘₐₓ previously determined. The Walker equation is used to determine a breaking stress value σₐ at 100,000 cycles:

$${σ}_{a} = {{σ}_{max} ( \frac{{N}_{0}}{N} )}^{1 / n}$$

where σₘₐₓ is the maximum stress applied to a given sample, N is the number of cycles until the rupture, N₀ is equal to 100,000 and n=−4.5.

For a given sheet metal, the average breaking stress value σ_{A} at 100,000 cycles corresponds to the average of three stress values σₐ.

In the context of the invention, two roughness parameters measured according to the standard NF EN ISO 4287 are used:
Rz: maximum height of the roughness profile,
Ra: mean deviation of roughness or the arithmetic mean of all the ordinates of the profile over the length of evaluation.

These parameters are evaluated in the context of the present invention in the directions L and T of the sheet metal by an optical interferometry method (61 profiles extracted in the directions L and T, the parameters Ra and Rz are representative of 90% of the surface analyzed p=0.90).

The surface residual stresses are evaluated by X-ray diffraction using a diffractometer equipped with a linear detector and an assembly ω. The measurement parameters used are:
Cr—Kα radiation;
crystallographic planes of the aluminum phases {311};
angle of diffraction 2θ₀=139.31°.

The analyses are carried out in the transverse direction, less affected by the crystallographic texture of the sample. The post-processing software StressAT was used, while taking into account an uncertainty of +/−2 standard deviation. The radiocrystallographic constants used for the calculation of residual stresses are S₁[MPa]=−5.11*10−6, and 1/2S₂[MPa]=19.54*10−6.

The evaluation of the residual stresses was carried out 0, 5, 10, 20 and 50 μm of depth from the extreme surface of the samples. For the analyses from 5 to 50pm from the extreme surface, a successive removal of material is carried out chemically (NaOH) in order to not introduce new residual stresses.

The present inventors have observed that, surprisingly, it is possible to obtain a rolled product made of Al—Cu—Li alloy having a thickness of less than 12 mm having both a better surface corrosion resistance and equivalent or even improved fatigue resistance properties, even when said product is later anodized, by carried out after the method for manufacturing said rolled product a quite particular step of brushing. The step of brushing is namely characterized by specific and critical parameters in terms of thickness of product eliminated, force applied during the brushing and orientation of the axis of rotation.

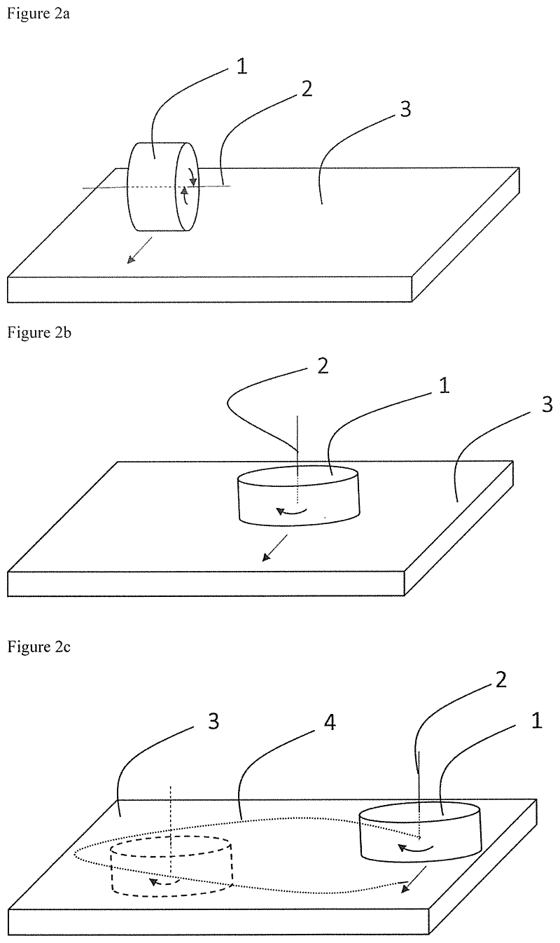

There is a plurality of brushing methods described in FIGS. 2a to 2c. FIG. 2a schematically shows the brushing called linear. In this type of brushing a brush 1 rotates about an axis of rotation 2 parallel to the brushed plane 3 and moves linearly with respect to this plane. Typically, the sheet metal is mobile and the brush is stationary.

FIG. 2b schematically shows the brushing called linear circular. In this type of brushing a brush 1 rotates about an axis of rotation 2 perpendicular to the brushed plane 3 and moves linearly with respect to this plane. Typically, the sheet metal is mobile and the brush is stationary.

FIG. 2c schematically shows the brushing called orbital circular. In this type of brushing a brush 1 rotates about an axis of rotation 2 perpendicular to the brushed plane 3 and moves while describing an orbit 4 with respect to this plane, while progressing with respect to the surface of the sheet metal. The orbit is typically an ellipse. Typically, the sheet metal is mobile and the brush is stationary.

Thus in the brushing of the circular type, the axis of rotation about which the brush rotates is perpendicular to the brushed plane.

In one embodiment of the method according to the invention, a rolled product made of Al—Cu—Li alloy is created, said rolled product is later solution heat treated and quenched, stress relieved preferably by stretching and optionally aged. The bath of liquid metal preferably comprises 2 to 4% Cu by weight, preferably from 2.2 to 3.6% Cu by weight, and even more preferably from 2.6 to 3.4% Cu by weight. The Al—Cu—Li alloy according to the invention advantageously comprises from 0.1% Li by weight and preferably up to 3% Li by weight, preferably from 0.5 to 1.1% Li by weight.

In another embodiment, the bath of liquid metal preferably comprises from 2.0 to 3.0% Cu by weight, and preferably from 2.3 to 2.7% Cu by weight and from 1.0 to 2.0% Li by weight and preferably from 1.3 to 1.6% Li by weight.

Optionally, the bath of liquid metal also comprises:
up to 0.5% Ag by weight, preferably from 0.1 to 0.4% Ag by weight,
up to 2% Mg by weight, preferably from 0.2 to 0.8% Mg by weight,
at least one element chosen from Zr and Ti and, if it is chosen, preferably from 0.11 to 20% Zr by weight and 0.01 to 0.15% Ti by weight,
optionally at least one element chosen from Mn, V, Cr, Sc and Hf, the quantity of the element, if it is chosen, being from 0.01 to 0.8% by weight for Mn, 0.05 to 0.2% by weight for V, 0.05 to 0.3% by weight for Cr, 0.02 to 0.3% by weight for Sc, 0.05 to 0.5% by weight for Hf,
a quantity of Zn of less than 0.6% by weight, a quantity of Fe and of Si less than or equal to 0.1% by weight each, and inevitable impurities at a concentration less than or equal to 0.05% by weight each and 0.15% by weight total.

According to a quite particular embodiment, the alloy of the bath of liquid metal is an AA2198 alloy.

The bath of liquid metal is cast in the form of a rolling ingot. The rolling ingot is homogenized preferably at a temperature between 450° C. and 515° C. then hot rolled into sheet metal having a thickness less than or equal to 12mm. Optionally, the sheet metal is also rolled by cold rolling into a sheet having a final thickness between 0.2 and 6 mm, preferably between 0.5 and 3.3 mm, the reduction in thickness carried out by cold rolling being between 1 and 3.5 mm. The sheet metal is then solution heat treated, preferably at a temperature between 450° C. and 515° C. then quenched. The solution heat treated and quenched sheet metal is stress relieved. Optionally, the stress relief is carried out by stretching and preferably, the stretching is carried out in a controlled manner with a permanent deformation of 0.5 to 5%. According to one embodiment, the stress relieved sheet metal is subjected to aging preferably at a temperature comprised between 130 and 170° C. and even more preferably between 150 and 160° C. for 5 to 100 hours, advantageously from 10 to 40 h.

After the manufacturing method which comprises in particular at least one step at a temperature greater than approximately 400° C., the surface of the sheet metal made of Al—Cu—Li alloy comprises a layer of oxides greater than 100 nm (0.1 μm), typically greater than 1 or even 2pm comprising lithium, oxygen, carbon and according to the composition of the alloy magnesium.

After the manufacturing method, the product according to the invention is subjected to a quite particular step of brushing, adapted specifically to the products made of Al—Cu—Li alloys. The brushing is carried out using a brushing tool such that it:
generates residual compression stresses at the surface of said product;
eliminates a thickness at least equal to 9 μm of the surface of the non-brushed rolled product; and wherein the brushing step comprises at least one brushing of the circular type.

In the sense of the invention, “superficial or surface residual compression stresses” means residual stresses substantially in the plane of the surface, these stresses affecting the product from the extreme surface (0 μm with respect to the surface of the product) and up to −50 μm, preferably −30 μm, even more preferably −20 μm from the extreme surface or even −10 μm from the extreme surface. According to the force applied onto the product during the brushing the residual compression stresses can affect the product over a lesser thickness.

The rolled product thus brushed has a layer of oxides less than 1 μm, preferably less than 0.4 μm and even more preferably less than 0.2 μm comprising for the most part oxygen and aluminum. In the present application, “for the most part oxygen and aluminum” means oxides comprising more than 70% by weight, preferably more than 85% by weight, even more preferably more than 90% by weight or even more than 95% by weight.

Advantageously, the force applied onto the rolled product during the brushing step generates residual compression stresses up to a thickness of at least 5 μm, preferably of at least 10 μm from the extreme surface of the product in the brushed state. The present inventors have observed that the products subjected to such a force during the brushing step have in particular improved fatigue properties with respect to non-brushed products, even when the brushed products are subsequently anodized, namely subjected to a chromic anodization typical of the aeronautics industry which is capable of generating a thickness of anode layer close to approximately 1 μm.

According to one embodiment, the force applied onto the rolled product during the brushing step is such that:
at the extreme surface, L.I. (brushed)−L.I. (non-brushed)>0.2°, preferably >0.3° and even more preferably >0.35°;
at −5 μm from the extreme surface, L.I. (brushed)−L.I. (non-brushed)>0.05°, preferably >0.1° and even more preferably >0.14°;
with L.I., the integral breadth at mid-height of the diffraction peak measured by X-rays and expressed in degree; L.I. (brushed) is the integral breadth measured on the rolled product after the step of brushing and L.I. (non-brushed) is the integral breadth measured on the rolled product before the step of brushing;
the residual compression stress in the direction T at the extreme surface of the rolled product in the brushed state is at least equal to −25 MPa, preferably to −45 MPa and, even more preferably −50 MPa.

According to an advantageous embodiment, the brushing tool eliminates a thickness at least equal to 10 μm of the surface of the non-brushed rolled product, preferably at least equal to 15 μm. Excellent results were obtained according to this embodiment, namely in terms of surface corrosion resistance, even in an environment particularly conducive to corrosion.

In one embodiment of the invention, adapted namely to the sheet metal in the metallurgical state T8, the brushing allows to obtain a surface of the rolled product such that:
the roughness Ra in the two directions (L) and (T) of the brushed rolled product is less than or equal to 1.5 μm;
the roughness Rz in the two directions (L) and (T) of the brushed rolled product is less than 8 μm.

and preferably such that:
the roughness Ra in the two directions (L) and (T) of the brushed rolled product is between 0.2 and 1.2 μm, preferably between 0.5 μm and 1.2 μm;
the roughness Rz in the two directions (L) and (T) of the brushed rolled product is between 1.3 and 8 μm, preferably between 1.5 and 8 μm, even more preferably between 2 and 8 μm.
In this embodiment, the present inventors obtained very good results, in particular in terms of fatigue resistance of the brushed products whether they were anodized or not.

In another embodiment of the invention namely adapted to the sheet metal in the metallurgical state T3, the brushing allows to obtain a surface of the rolled product such that:
the roughness Ra in the two directions (L) and (T) of the brushed rolled product is less than or equal to 4 μm;
the roughness Rz in the two directions (L) and (T) of the brushed rolled product is less than 17 μm.

and preferably such that:
the roughness Ra in the two directions (L) and (T) of the brushed rolled product is between 0.5 and 3.5 μm, preferably between 1.0 μm and 3.0 μm;
the roughness Rz in the two directions (L) and (T) of the brushed rolled product is between 8 and 16 μm, preferably between 10 and 15 μm.

The brushing step comprises at least one brushing of the circular type. The circular brushing can be a circular and linear or circular and orbital brushing or a combination of these brushings. Advantageously, the brushing is of the circular and orbital type. Indeed, the present inventors have observed that the productivity of this method is improved in the case of the circular and orbital brushing.

The invention also relates to the products obtained by the method according to the invention.

Advantageously the brushed rolled product made of Al—Cu—Li alloy having a thickness of less than 12 mm obtained by the method according to the invention has namely in the state T8:
a roughness Ra in the two directions (L) and (T) of the brushed rolled product less than or equal to 1.5 μm;
a roughness Rz in the two directions (L) and (T) of the brushed rolled product of less than 8 μm;

and preferably
a roughness Ra in the two directions (L) and (T) of the brushed rolled product between 0.2 and 1.2 μm, preferably between 0.5 μm and 1.2 μm;
a roughness Rz in the two directions (L) and (T) of the brushed rolled product between 1.3 and 8 μm, preferably between 1.5 and 8 μm, even more preferably between 2 and 8 μm; and/or
surface residual stresses in the direction T such that:
at the extreme surface, the residual stress is a compression stress at least equal to −25 MPa, preferably to −45 MPa and, even more preferably −50 MPa;

at the extreme surface, L.I. (brushed)>1.5°, preferably >1.6°;
at −5 μm from the extreme surface, L.I. (brushed)>01.4°, preferably >1.5° with L.I., the integral breadth at mid-height of the diffraction peak measured by X-rays and expressed in degree; and/or
surface oxides comprising as majority elements oxygen and aluminum, the thickness of these oxides at the surface of the brushed product being less than 1 μm, preferably less than 0.4 μm and even more preferably less than 0.2 μm.

In another embodiment the brushed rolled product made of Al—Cu—Li alloy having a thickness of less than 12 mm obtained by the method according to the invention has namely in the state T3:
a roughness Ra in the two directions (L) and (T) of the brushed rolled product less than or equal to 4 μm;
a roughness Rz in the two directions (L) and (T) of the brushed rolled product of less than 17 μm.

and preferably
a roughness Ra in the two directions (L) and (T) of the brushed rolled product between 0.5 and 3.5 μm, preferably between 1.0 μm and 3.0 μm;
a roughness Rz in the two directions (L) and (T) of the brushed rolled product between 8 and 16μm, preferably between 10 and 15 μm; and/or
surface residual stresses in the direction T such that:
at the extreme surface, the residual stress is a compression stress at least equal to −25 MPa, preferably to −45 MPa and, even more preferably −50 MPa;
at the extreme surface, L.I. (brushed)>1.5°, preferably >1.6°;
at −5 μm from the extreme surface, L.I. (brushed)>01.4°, preferably >1.5° with L.I., the integral breadth at mid-height of the diffraction peak measured by X-rays and expressed in degree; and/or
surface oxides comprising as majority elements oxygen and aluminum, the thickness of these oxides at the surface of the brushed product being less than 1 μm, preferably less than 0.4 μm and even more preferably less than 0.2 μm.

Such products have both excellent properties of surface corrosion resistance even when it is subjected to long-term storage and / or storage in particularly unfavorable temperature and humidity conditions.

The brushed product according to the invention has improved fatigue properties with respect to an identical non-brushed product, the two products being in the anodized state or not. According to an advantageous embodiment, the product even has improved fatigue properties with respect to an identical non-brushed product, preferably an average breaking stress value σ_{A} at 100,000 cycles greater than that of an identical non-brushed product.

Advantageously the product according to the invention is sheet metal and more preferably a sheet, even more preferably a fuselage sheet. The product according to the invention can thus advantageously be used in a fuselage panel for an aircraft.

These aspects, as well as others of the invention are explained in more details using the following illustrative and non-limiting examples.

### EXAMPLES

All the examples below were obtained for sheet metal made of AA2198 alloy 3.1 mm thick. It was prepared by a method comprising the steps of casting, homogenization, hot then cold rolling, solution heat treatment and quenching, stretching and optionally aging. The sheet metal having undergone aging is in a T8 metallurgical state, more precisely in the metallurgical state T851 after said method whereas the sheet metal of test 2c which has not undergone aging is in a T3 state.

### Example 1

Various types of surface treatment were used on the sheet metal described above, the parameters of these treatments are detailed in table 1 below. The sheet metal thus treated was subjected to a neutral salt spray corrosion test (1h) according to the standard ASTM B117. The absence of spots of corrosion (“pitting”) on the surface indicates that the sheet metal passes the corrosion test (corrosion test indicated “OK” in table 1).

TABLE 1

| | | Thickness | |
|---|---|---|---|
| | | removed by | Corrosion test |
| Test | Type of treatment | brushing (μm) | (1h ASTM B117) |
| 1 | None | 0 | No Ok |
| 14 | shot blasting | 0 | No Ok |
| 15 | Circular and orbital | 5 | No OK |
| | Brushing | | |
| 16 | Circular and orbital | 8 | No OK |
| | Brushing | | |
| 17 | Circular and orbital | 10 | Ok |
| | Brushing | | |
| 2 | Circular and orbital | 20 | Ok |
| | Brushing | | |
| 2c | Circular and orbital | 20 | Ok |
| | Brushing | | |
| 8 | Circular and linear | 50 | Ok |
| | Brushing | | |
| 10 | Circular and linear | 70 | Ok |
| | Brushing | | |
| 11 | Linear Brushing | 40 | Ok |

The examples for which the thickness removed falls under the invention have a satisfactory result for the corrosion test.

### Example 2

Table 2 presents the fatigue properties (Kt=1) of sheet metal for which the thickness removed falls under the invention. The impact of various types of brushing was studied: absence of brushing or linear, circular and linear, circular and orbital brushing. The fatigue was evaluated, as described above directly in the description, after brushing and after an anodization treatment as described in the present application. The roughness (Ra and Rz) was also measured according to the method described above.

TABLE 2

| | | | | Roughness parameters | | | |
|---|---|---|---|---|---|---|---|
| | | Non-anodized | | obtained by interferometry | | | |
| | | product | Anodized product | (P = 0.90) | | | |
| | | Direction T-L | Direction T-L | L | | TL | |
| | Type of | σ10⁵ cycles | σ10⁵ cycles | Ra | Rz | Ra | Rz |
| Test | brushing | MPa | MPa | μm | μm | μm | μm |
| 1 | None | 341 | 305 | 0.2 | 0.2 | 0.6 | 3.4 |
| 2 | Circular | 381 | 309 | 1.1 | 7.0 | 1.1 | 6.4 |
| | and | | | | | | |
| | orbital | | | | | | |
| 2c | Circular | 375 | 316 | 2.8 | 13.9 | 2.8 | 13.3 |
| | and | | | | | | |
| | orbital | | | | | | |
| 7 | Circular | 358 | 315 | 1.0 | 5.9 | 0.9 | 5.7 |
| | and | | | | | | |
| | orbital | | | | | | |
| 8 | Circular | 385 | 336 | 0.3 | 2.2 | 0.7 | 5.5 |
| | and | | | | | | |
| | linear | | | | | | |
| 11 | Linear | 225 | 200 | 1.4 | 8.6 | 3.1 | 20.8 |
| 12 | Linear | 248 | 217 | 0.4 | 3.2 | 1.0 | 8.4 |
| 13 | Linear | 290 | 250 | 0.3 | 2.2 | 0.5 | 4.1 |

The tests in which a brushing of the circular type is carried out have improved fatigue performance, with namely an average breaking stress value σ_{A} at 100,000 cycles greater than that of an identical non-brushed product.

### Example 3

The surface residual stresses on of non-brushed sheet metal and of brushed sheet metal (combination of circular brushing and orbital brushing) were evaluated according to the method described above in the present application. The compression stresses in the directions T were evaluated in the thickness of the sheet metal from the extreme surface and up to −50 μm from the extreme surface. The zone affected by the plastic deformation induced by the brushing is correlated with the increase in the integral breadth of diffraction peak L.I.

TABLE 3

| | | | Residual stresses by XRD | |
|---|---|---|---|---|
| | | | | Integral |
| | | Position from | Stresses | Breadth (L.I.) |
| | Type of | the extreme | direction T | direction T |
| Test | brushing | surface (μm) | MPa | degree ° |
| 1 | none | 0 | −7.0 | 1.3 |
| | | −5 | −5.0 | 1.3 |
| | | −10 | −43.0 | 1.3 |
| | | −20 | −23.0 | 1.4 |
| | | −50 | −43.0 | 1.4 |
| 2 | circular and | 0 | −68.0 | 1.7 |
| | orbital | −5 | −77.0 | 1.6 |
| | | −10 | −106.0 | 1.4 |
| | | −20 | −68.0 | 1.3 |
| | | −50 | −39.0 | 1.4 |
| 2c | circular and | 0 | −59.0 | 1.7 |
| | orbital | −5 | −71.0 | 1.5 |
| | | −10 | −60.0 | 1.4 |
| | | −20 | −10.0 | 1.4 |
| | | −50 | −24.0 | 1.4 |
| 11 | linear | 0 | −139.0 | 2.5 |
| | | −5 | −109.0 | 2.2 |
| | | −10 | −139.0 | 2.2 |
| | | −20 | −25.0 | 2.0 |
| | | −50 | −25.0 | 1.7 |

1. Method for manufacturing a brushed rolled product made of an Al—Cu—Li alloy having a thickness of less than 12 mm comprising a step of brushing such that the brushing tool:
generates residual compression stresses at the surface of the brushed product;
eliminates a thickness at least equal to 9 μm of the surface of the non-brushed rolled product,
wherein the brushing step comprises at least one brushing of the circular type.

2. Method according to claim 1 comprising, before the brushing step, the steps:
creation of a rolled product;
solution heat treatment and quenching;
stress relief preferably by stretching;
optionally aging.

3. Method according to claim 1 such that the force applied onto the rolled product during the brushing step generates residual compression stresses up to a thickness of at least 5 μm, preferably at least 10 μm from the extreme surface of the product in the brushed state.

4. Method according to claim 1 such that the force applied onto the rolled product during the brushing step is such that:
at the extreme surface, L.I. (brushed)−L.I. (non-brushed)>0.2°, preferably >0.3° and even more preferably >0.35°;
at −5 μm from the extreme surface, L.I. (brushed)−L.I. (non-brushed)>0.05°, preferably >0.1° and even more preferably >0.14°;
with L.I., the integral breadth at mid-height of the diffraction peak measured by X-rays and expressed in degree; L.I. (brushed) is the integral breadth measured on the rolled product after the step of brushing and L.I. (non-brushed) is the integral breadth measured on the rolled product before the step of brushing;
the residual compression stress in the direction T at the extreme surface of the rolled product in the brushed state is at least equal to −25 MPa, preferably to −45 MPa and, even more preferably −50 MPa.

5. Method according to claim 1 such that the brushing tool eliminates a thickness at least equal to 10 μm of the surface of the non-brushed rolled product, preferably at least equal to 15 μm.

6. Method according to claim 1 such that the brushing tool allows to obtain a surface of said rolled product such that:
the roughness Ra in the two directions (L) and (T) of the brushed rolled product is less than or equal to 1.5 μm;
the roughness Rz in the two directions (L) and (T) of the brushed rolled product is less than 8 μm, and preferably
the roughness Ra in the two directions (L) and (T) of the brushed rolled product is between 0.2 and 1.2 μm, preferably between 0.5 μm and 1.2 μm;
the roughness Rz in the two directions (L) and (T) of the brushed rolled product is between 1.3 and 8 μm, preferably between 1.5 and 8 μm, even more preferably between 2 and 8 μm.

7. Method according to claim 1 such that the brushing tool allows to obtain a surface of said rolled product such that:
the roughness Ra in the two directions (L) and (T) of the brushed rolled product is less than or equal to 4 μm;
the roughness Rz in the two directions (L) and (T) of the brushed rolled product is less than 17 μm, and preferably
the roughness Ra in the two directions (L) and (T) of the brushed rolled product is between 0.5 and 3.5 μm, preferably between 1.0 μm and 3.0 μm;
the roughness Rz in the two directions (L) and (T) of the brushed rolled product is between 8 and 16 μm, preferably between 10 and 15 μm.

8. Brushed rolled product made of Al—Cu—Li alloy having a thickness of less than 12 mm capable of being obtained by the method according to claim 1.

9. Brushed rolled product according to claim 8, characterized in that it has:
a roughness Ra in the two directions (L) and (T) of the brushed rolled product less than or equal to 1.5 μm;
a roughness Rz in the two directions (L) and (T) of the brushed rolled product of less than 8 μm; and/or
surface residual stresses in the direction T such that:
at the extreme surface, the residual stress is a compression stress at least equal to −25 MPa, preferably to −45 MPa and, even more preferably −50 MPa;
at the extreme surface, L.I. (brushed)>1.5°, preferably >1.6°;
at −5 μm from the extreme surface, L.I. (brushed)>1.4°, preferably >1.5°
with L.I., the integral breadth at mid-height of the diffraction peak measured by X-rays and expressed in degree; and/or
surface oxides comprising as majority elements oxygen and aluminum, the thickness of these oxides at the surface of the brushed product being less than 1 μm, preferably less than 0.4 μm and even more preferably less than 0.2 μm.

10. Brushed rolled product according to claim 8, characterized in that it has:
a roughness Ra in the two directions (L) and (T) of the brushed rolled product less than or equal to 4 μm;
a roughness Rz in the two directions (L) and (T) of the brushed rolled product of less than 17 μm and/or
surface residual stresses in the direction T such that:
at the extreme surface, the residual stress is a compression stress at least equal to −25 MPa, preferably to −45 MPa and, even more preferably −50 MPa;
at the extreme surface, L.I. (brushed)>1.5°, preferably >1.6°;
at −5 μm from the extreme surface, L.I. (brushed)>1.4°, preferably >1.5°
with L.I., the integral breadth at mid-height of the diffraction peak measured by X-rays and expressed in degrees; and/or
surface oxides comprising as majority elements oxygen and aluminum, the thickness of these oxides at the surface of the brushed product being less than 1 μm, preferably less than 0.4 μm and even more preferably less than 0.2 μm.

11. Product according to claim 8 such that it is a sheet having a thickness between 0.2 and 6 mm, preferably 0.5 and 3.3 mm.

12. Product according to claim 8, characterized in that it has improved fatigue properties with respect to an identical non-brushed product, preferably an average breaking stress value σA at 100,000 cycles greater than that of an identical non-brushed product.

13. Use of a brushed rolled product according to claim 8 in a fuselage panel for an aircraft.
